(19) United States
(12) Patent Application Publication
(10) Pub. No.: US 2019/0290973 A1
(43) Pub. Date: Sep. 26, 2019

(54) GOLF CLUB HEAD

(71) Applicant: BRIDGESTONE SPORTS CO.,LTD., Tokyo (JP)

(72) Inventor: Tomonori KITAGAWA, Tokyo (JP)

(21) Appl. No.: 16/274,446

(22) Filed: Feb. 13, 2019

(30) Foreign Application Priority Data
Mar. 23, 2018 (JP) 2018-055822
Mar. 23, 2018 (JP) 2018-055823
Mar. 23, 2018 (JP) 2018-055824

(51) Int. Cl. A63B 53/04

(52) U.S. Cl. CPC A63B 53/0466; B32B 15/02

(57) ABSTRACT

A golf club head of a wood type includes a face, a sole, and a crown. The crown includes a crown member. The crown member includes a first member and a second member. The first member includes a fiber-reinforced resin, and the second member is formed of a metallic wire. The second member is elongated in a toe-heel direction.

### CROSS-REFERENCE TO RELATED APPLICATIONS

This application is based upon and claims priority to Japanese patent application Nos. 2018-055822, 2018-055823, and 2018-055824, each filed on Mar. 23, 2018, the entire contents of which are hereby incorporated herein by reference.

### BACKGROUND OF THE INVENTION

### 1. Field of the Invention

The present invention generally relates to golf club heads.

### 2. Description of the Related Art

According to conventional golf club heads, in order to improve golf ball striking performance, consideration is given to facilitating flexure of a crown. At the same time, the strength of the crown as well is important, and in order to improve the strength of the crown, for example, a fiber-reinforced resin or the like is used as a material forming the crown. See, for example, Japanese Patent Nos. 4759333 and 4403084 and Japanese Laid-open Patent Publication Nos. 2005-137819 and 2000-229135.

### SUMMARY OF THE INVENTION

According to an aspect of the present invention, a golf club head of a wood type includes a face, a sole, and a crown including a crown member. The crown member includes a first member including a fiber-reinforced resin and a second member of a metallic wire. The second member is elongated in a toe-heel direction.

According to an aspect of the present invention, a golf club head of a wood type includes a face, a sole, and a crown including a crown member. The crown member includes a first member including a fiber-reinforced resin and a second member of a metallic wire. The second member has a higher flexural rigidity in a toe-heel direction than in a face-back direction.

The object and advantages of the invention will be realized and attained by means of the elements and combinations particularly pointed out in the claims.

It is to be understood that both the foregoing general description and the following detailed description are exemplary and explanatory and not restrictive of the invention.

### BRIEF DESCRIPTION OF THE DRAWINGS

FIGS. 1A and 1B are diagrams illustrating a golf club head according to an embodiment;

FIGS. 2A and 2B are exploded views of the golf club head according to the embodiment;

FIG. 3 is an exploded perspective view of a layered structure of a crown member according to the embodiment; and

FIG. 4 is an exploded perspective view of another layered structure of the crown member according to the embodiment.

### DETAILED DESCRIPTION OF THE PREFERRED EMBODIMENTS

As noted above, according to conventional golf club heads, consideration is given to facilitating the flexure of a crown and also improving the strength of the crown. Depending on a material forming the crown and the manner of placement of the material, however, the improved strength of the crown may interfere with the flexure of the crown.

According to an aspect of the present invention, it is possible to provide a golf club head in which the strength of a crown is improved without interference with the flexure of the crown.

One or more embodiments are described below with reference to the accompanying drawings. In the following description, the same elements are referred to using the same reference numeral, and duplicate description thereof may be omitted.

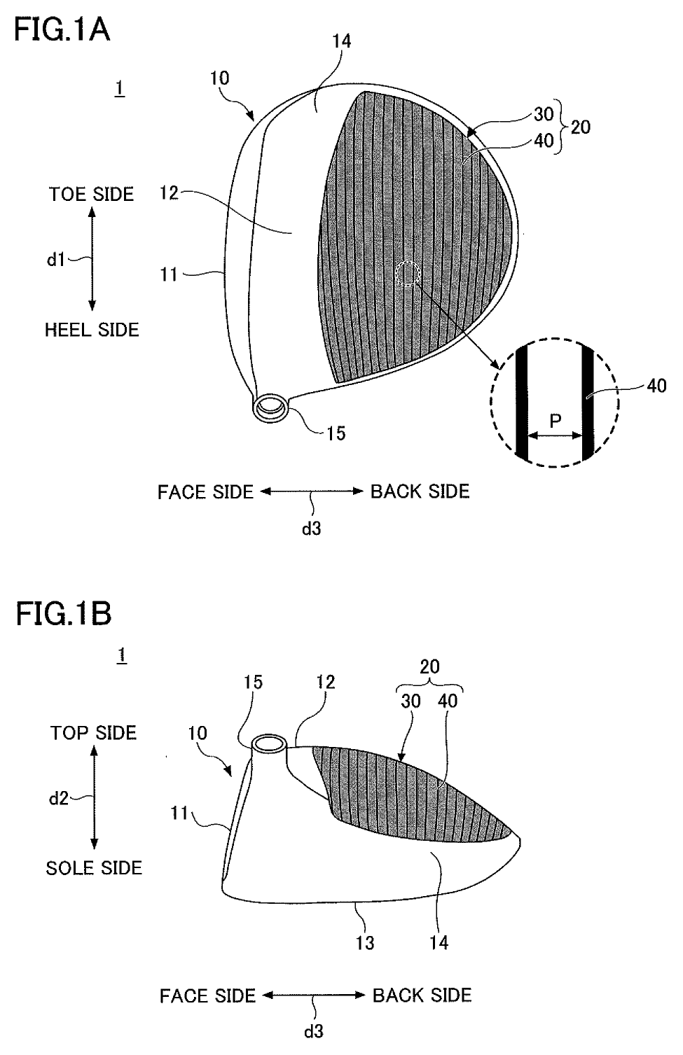

FIGS. 1A and 1B are a plan view and a right side view, respectively, of a golf club head 1 according to an embodiment. In FIGS. 1A and 1B, the double-headed arrow d1 indicates the “toe-heel” (left-right) direction, namely, the direction from the toe side to the heel side or the direction from the heel side to the toe side, of the golf club head 1, the double-headed arrow d2 indicates the “top-sole” (up-down) direction, namely, the direction from the top side to the sole side or the direction from the sole side to the top side, of the golf club head 1, and the double-headed arrow d3 indicates the “face-back” (front-rear) direction, namely, the direction from the face side to the back side or the direction from the back side to the face side, of the golf club head 1.

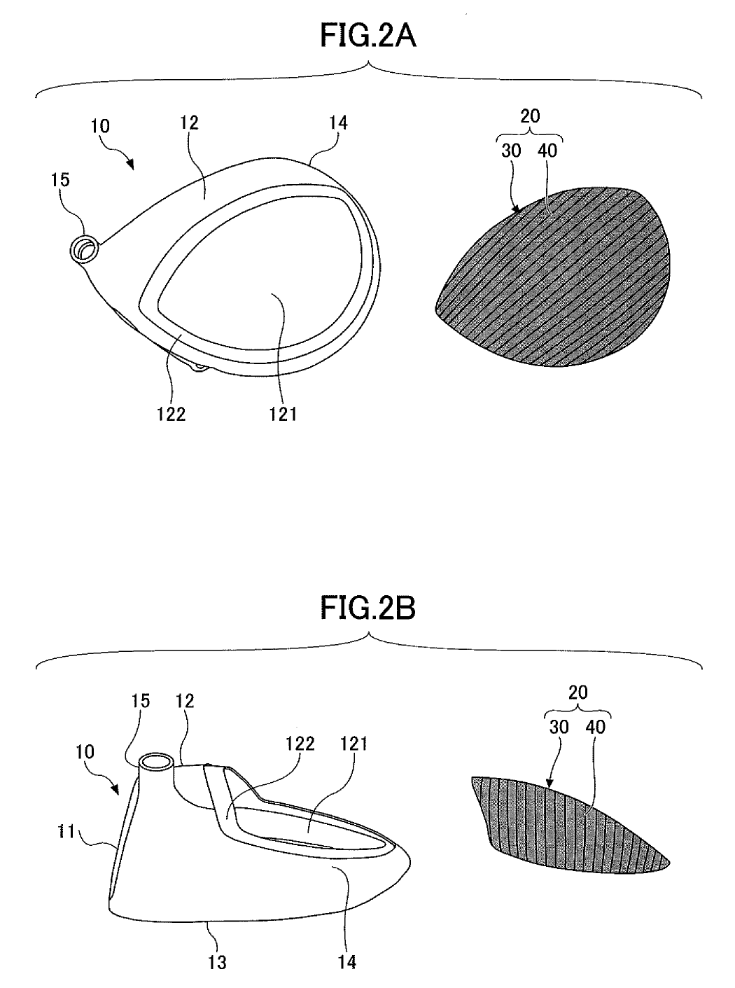

FIG. 2A is an exploded top-side perspective view of a head body member 10 and a crown member 20 of the golf club head 1. FIG. 2B is an exploded right-side view of the head body member 10 and the crown member 20.

The golf club head 1 depicted in FIGS. 1A through 2B is a wood-type (wood-style) golf club head such as a driver club head, but may also be a hybrid club head or a fairway wood club head. Multiple parts may be joined and assembled into the golf club head 1. The golf club head 1 is described in more detail below.

The golf club head 1 is a hollow structure that includes the head body member 10 and the crown member 20 fixedly secured to the head body member 10. An internal surface of the hollow structure may be referred to as “head internal surface” and an external surface of the hollow structure may be referred to as “head external surface.”

The head body member 10 includes a face 11, a crown 12, a sole 13, a sidewall 14, and a hosel 15.

The face 11 defines a front portion of the golf club head 1, and includes a face surface that defines a ball-striking surface between the crown 12 and the sole 13 of the golf club head 1 in the top-sole direction. The crown 12, together with the crown member 20, defines a top portion (crown) of the golf club head 1. The details of the structures of the crown 12 and the crown member 20 are described below. The sole 13 defines a bottom portion of the golf club head 1. The sidewall 14 extends between the crown 12 and the sole 13 to define a curved periphery of the golf club head 1 that is continuous with the face surface. The hosel 15 receives a shaft.

The crown 12 of the head body member 10 includes an opening 121 and a stepped part 122 so formed as to surround the opening 121. The stepped part 122 is positioned a step below the head external surface, and can position and hold the outer edge portion of the crown member 20, which can be fixedly secured to the stepped part 122. The crown member 20 is attached to the stepped part 122 of the crown 12 of the head body member 10 with an adhesive or the like to close the opening 121.

Suitable methods of manufacturing the head body member 10 include, for example, casting, forging, 3D printing, and other forming methods. Suitable materials for the head body member 10 include, for example, metallic materials, non-metallic materials, and materials lower in specific gravity than metallic materials. Specific examples of such materials include titanium, titanium alloys, stainless steel, aluminum, aluminum alloys, iron-based metals, magnesium, magnesium alloys, and fiber-reinforced resins.

The crown member 20 includes a resin part 30 and a metallic wire 40, and forms part of the crown 12. The resin part 30 includes a fiber-reinforced resin. The resin part 30 is a typical example of a first member according to the embodiment.

Here, the fiber-reinforced resin is a composite material of a resin and fibers to serve as a reinforcing material. Examples of the fibers of the fiber-reinforced resin include glass fibers, carbon fibers, aramid fibers, polyethylene fibers, Zyron®, and boron fibers. Examples of the resin of the fiber-reinforced resin include epoxy resins, phenolic resins, polyester resins, and polycarbonate resins.

The resin part 30 may be formed by layering multiple sheets of fiber-reinforced resin, and heating the layered structure while applying pressure to the layered structure. The layered structure may include a unidirectional (UD) prepreg layer of unidirectionally oriented reinforcing fibers impregnated with resin. Alternatively, to distribute stress, the layered structure may be alternate layers of a fiber-reinforce resin of a 90° fiber direction and a fiber-reinforce resin of a 0° fiber direction. The 0° fiber direction indicates that fibers are oriented in the toe-heel direction. The 90° fiber direction indicates that fibers are oriented in the face-back direction.

The resin part 30 may include other members in addition to a fiber-reinforced resin. Examples of other members include a resin that does not include fibers to serve as a reinforcing material.

The metallic wire 40 is included in the resin part 30 in such a manner as to be visible from outside the golf club head 1. The metallic wire 40 is elongated in the toe-heel direction. Here, being elongated in the toe-heel direction means that the metallic wire 40 connects any point on the toe side and any point on the heel side within the crown member 20. While approximately oriented in the d1 direction illustrated in FIG. 1A, the metallic wire 40 does not necessarily have to be completely parallel to the d1 direction.

By orienting the metallic wire 40 in the toe-heel direction, the flexural rigidity can be higher in the toe-heel direction than in the face-back direction. Suitable materials for the metallic wire 40 include, for example, crystal alloys and non-crystalline alloys. Specific examples of such materials include titanium nickel. The cross-sectional shape of the metallic wire 40 is, for example, a circle including an ellipse, or a polygon. The cross section of the metallic wire 40 is, for example, approximately 0.1 mm to approximately 2.0 mm in width where the cross section is narrowest.

Multiple metallic wires 40 may be included in the resin part 30 in such a manner as to be visible from outside the golf club head 1. In this case, the metallic wires 40 may be arranged such that each of the metallic wires 40 is elongated in the toe-heel direction. Furthermore, the metallic wires 40 may be arranged in such a manner as to be substantially parallel to each another and be adjacent to each other in the face-back direction.

Here, being substantially parallel means that a difference between the maximum value and the minimum value of the interval between adjacent metallic wires 40 is 1 mm or less when the golf club head 1 is soled on a horizontal plane at a reference lie angle and a reference loft angle and viewed in a direction normal to the horizontal plane. When viewed in a direction normal to the horizontal plane, the metallic wires 40 do not have to look rectilinear and may look curved. Furthermore, the metallic wires 40 may include those looking rectilinear and those looking curved in mixture.

The metallic wires 40 are substantially uniformly spaced, namely, spaced at substantially regular intervals. Here, being substantially uniformly spaced means that the error of an interval P between the n^{th} metallic wire 40 and the (n+1)^{th} metallic wire 40 is within ±1 mm regardless of the value of n (where n is a natural number).

The crown member 20 may be formed into a predetermined shape by, for example, sandwiching multiple metallic wires to become the metallic wires 40 between multiple prepregs to become the resin part 30, and applying pressure to the structure of the metallic wires and prepregs while heating the structure. Coating or the like may be applied to the crown member 20 on an as-needed basis. Furthermore, processing such as polishing and machining may be performed on the entire surface of the crown member 20 on an as-needed basis.

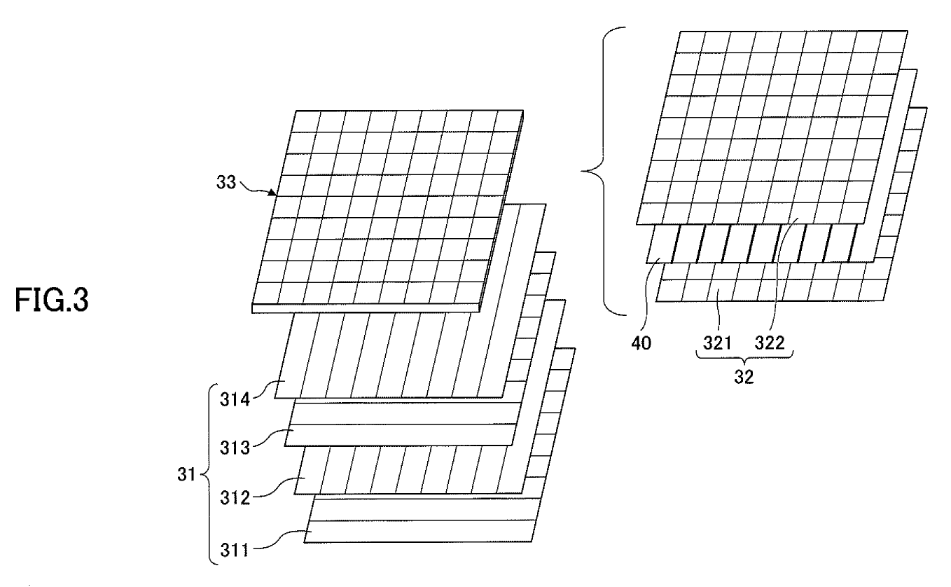

FIG. 3 is an exploded perspective view of a layered structure of the crown member 20. As illustrated in FIG. 3, the crown member 20 may include a member 31 and a member 33 that are successively stacked in layers, for example. Because the surface of the crown member 20 is vulnerable, a transparent resin such as a color clear coat may be further provided as an outermost layer (on the member 33).

The member 33 is a laminate having the metallic wire or wires 40 sandwiched between members 32. The resin part 30 illustrated in FIGS. 1A through 2B may be formed of the members 31 and 32. The member 31 is another typical example of the first member according to the embodiment. The metallic wire or wires 40 are a typical example of a second member according to the embodiment. In the following, the metallic wire or wires 40 are simply referred to as “metallic wires 40” for convenience of description.

The member 31 includes members 311, 312, 313 and 314. The member 311 is a fiber-reinforced resin of the 90° fiber direction. The member 312 is a fiber-reinforced resin of the 0° fiber direction. The member 313 is a fiber-reinforced resin of the 90° fiber direction. The member 314 is a fiber-reinforced resin of the 0° fiber direction.

Because the member 31 has a layered structure of the members 311, 312, 313 and 314, the member 31 is balanced between the face-back direction and the toe-heel direction with respect to the fiber direction. Therefore, the member 31 has substantially the same flexural rigidity in the face-back direction and in the toe-heel direction. Here, having substantially the same flexural rigidity means that the difference between the flexural rigidity in the face-back direction and the flexural rigidity in the toe-heel direction is within ±10%.

The number of layers of members of the member 31 is not limited to the extent that the flexural rigidity in the face-back direction and the flexural rigidity in the toe-heel direction are substantially equal. For example, the member 31 may have a structure where a single layer of a fiber-reinforced resin of the 90° fiber direction and a single layer of a fiber-reinforced resin of the 0° fiber direction are stacked or three or more layers of a fiber-reinforced resin of the 90° fiber direction and three or more layers of a fiber-reinforced resin of the 0° fiber direction are alternately stacked. Furthermore, the member 31 may include any number of resin layers free of fibers to serve as a reinforcing material, and may include any number of fiber-reinforced resin layers each equal in rigidity in the 0° direction and in the 90° direction.

The member 33 is a laminate of a member 321 forming part of the members 32, the metallic wires 40, and a member 322 forming part of the members 32 that are successively stacked in layers. The member 321 is placed inside the metallic wires 40 and the member 322 is placed outside the metallic wires 40 in the golf club head 1. The member 322 is placed at the outermost layer of the crown member 20, and is so transparent as to make the metallic wires 40 visible from outside the golf club head 1. The members 321 and 322 are typical examples of third members according to the embodiment.

The members 321 and 322 are a fiber-reinforced resin including glass fibers as a reinforcing material. The glass fibers of the members 321 and 322 are preferably woven crisscross. When the glass fibers are woven crisscross, it is possible to substantially equalize the flexural rigidity in the face-back direction and the flexural rigidity in the toe-heel direction by orienting the members 32 such that the fibers are oriented in the 0° direction and in the 90° direction or in the ±45° directions in the face-back direction and in the toe-heel direction.

Furthermore, because glass fibers contribute less to rigidity than carbon fibers, by using a fiber-reinforced resin including glass fibers as the members 321 and 322, it is possible to increase the strength (thickness) of the crown 12 without interference with the advantageous deformation or returning of the crown 12. Furthermore, irregularities due to the metallic wires 40 are eliminated by glass fibers to make the surface of the crown member 20 even and less vulnerable.

While the metallic wires 40 are depicted as a sheet member for convenience in FIG. 3, in practice, for example, the metallic wires 40 are oriented in the toe-heel direction, substantially parallel to each other at substantially regular intervals, between the members 321 and 322.

Thus, by orienting the metallic wires 40 in the toe-heel direction in the crown member 20 of the golf club head 1, it is possible to make flexural rigidity higher in the toe-heel direction than in the face-back direction. As a result, it is possible to increase the strength of the crown 12 without interference with the flexure or repulsion of the crown 12 in the face-back direction at the time of striking a ball.

Orienting the metallic wires 40 in the face-back direction in the crown member 20 is not preferable because the metallic wires 40 then serve to interfere with the flexure or repulsion of the crown 12 at the time of striking a ball. Furthermore, using a metal sheet in place of the metallic wires 40 is not preferable because the metal sheet is heavy and increases the overall weight of the golf club head 1.

Furthermore, by orienting the metallic wires 40 in the toe-heel direction such that the metallic wires 40 are externally visible in the crown member 20 of the golf club head 1, the metallic wires 40 serve as an alignment mark. This makes it easier for a hitter to see the target line. That is, when the golf club head 1 is soled on a horizontal plane at a reference lie angle and a reference loft angle at address, the metallic wires 40 can look perpendicular to the target line to a hitter. Therefore, the hitter can accurately align the golf club head 1 with the target line.

Because the crown 12 has a curved surface that bulges outward and the golf club head 1 is soled at a lie angle at address, a hitter can take her/his address more easily with the metallic wires 40 oriented in the toe-heel direction than in the face-back direction.

Furthermore, by increasing rigidity selectively in the toe-heel direction and visualizing the direction of the metallic wires 40 in alignment with a direction of higher rigidity, it is possible to give a hitter the impression that the crown 12 has a high flexural rigidity in the toe-heel direction. Because the hitter's impression based on appearance matches the actual rigidity, the hitter can strike a ball without a feeling of strangeness and is more likely to have a good ball striking result.

Furthermore, by using a fiber-reinforced resin including glass fibers as the members 321 and 322 in the crown member 20 of the golf club head 1, it is possible to increase the strength of the crown 12 without interference with the flexure or repulsion of the crown 12 in the face-back direction at the time of striking a ball.

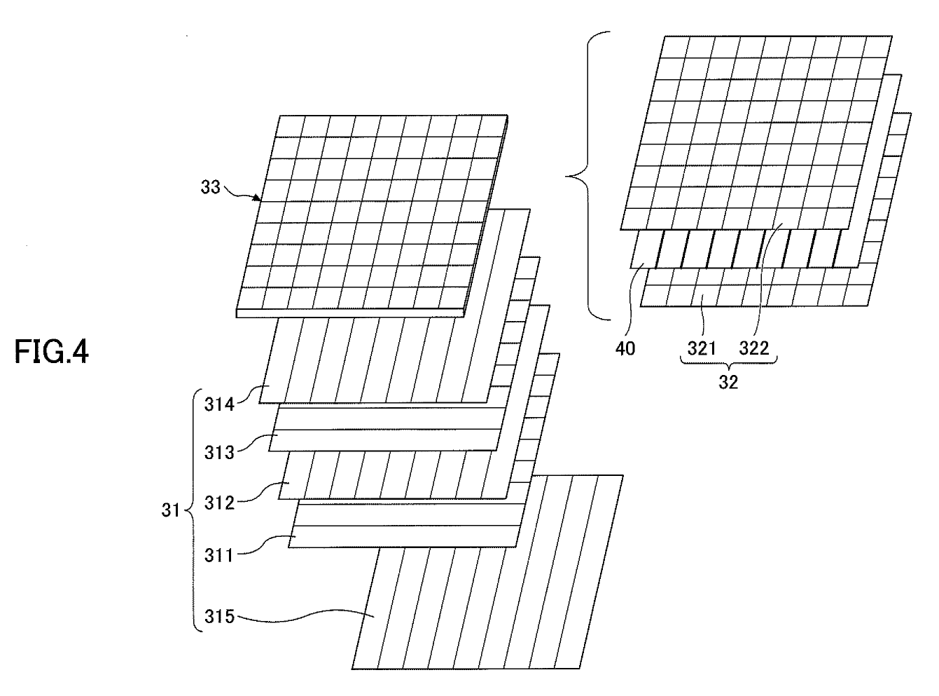

FIG. 3 illustrates the case where the flexural rigidity in the face-back direction and the flexural rigidity in the toe-heel direction are substantially equal in the member 31. Alternatively, the member 31 may have a higher flexural rigidity in the toe-heel direction than in the face-back direction. This is illustrated with reference to FIG. 4.

FIG. 4 is an exploded perspective view of another layered structure of the crown member 20. As illustrated in FIG. 4, the member 31 includes an additional member 315. The additional member 315 is formed of a fiber-reinforced resin and is so oriented as to have a fiber direction in the toe-heel direction.

In FIG. 4, by way of example, the additional member 315 is provided as the lowermost layer. This, however, is a non-limiting example, and the additional member 315 may be placed at any position in the member 31. For example, the additional member 315 may be placed over the member 314, between the members 311 and 312, between the members 312 and 313, or between the members 313 and 314.

Thus, by adding a fiber-reinforced resin so oriented as to have a fiber direction in the toe-heel direction to the member 31, the member 31 has a higher flexural rigidity in the toe-heel direction than in the face-back direction. As a result, the member 31 and the metallic wires 40 match in a direction of higher rigidity. Therefore, it is possible to make flexural rigidity yet higher in the toe-heel direction than in the face-back direction in the golf club head 1. As a result, it is possible to further increase the strength of the crown 12 without interference with the flexure or repulsion of the crown 12 in the face-back direction at the time of striking a ball.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority or inferiority of the invention. Although one or more embodiments of the present invention have been described in detail, it should be understood that the various changes, substitutions, and alterations could be made hereto without departing from the spirit and scope of the invention.

What is claimed is:

1. A golf club head of a wood type, comprising:
a face;
a sole; and
a crown including a crown member,
the crown member including
a first member including a fiber-reinforced resin; and
a second member of a metallic wire, the second member being elongated in a toe-heel direction.

2. The golf club head as claimed in claim 1, wherein the second member is visible from an outside of the golf club head.

3. The golf club head as claimed in claim 1, wherein the second member includes a plurality of second members of metallic wires, the plurality of second members being substantially parallel to each other, the plurality of second members being adjacent to each other in a face-back direction.

4. The golf club head as claimed in claim 3, wherein the plurality of second members adjacent to each other are substantially uniformly spaced.

5. The golf club head as claimed in claim 1, wherein
the crown member further includes a plurality of third members of a fiber-reinforced resin including glass fibers, and
one of the plurality of third members is placed inside the second member and another one of the plurality of third members is placed outside the second member in the golf club head.

6. The golf club head as claimed in claim 5, wherein one of the plurality of third members is placed at an outermost layer of the crown member, and is so transparent as to make the second member visible from an outside of the golf club head.

7. The golf club head as claimed in claim 5, wherein the glass fibers are woven crisscross.

8. A golf club head of a wood type, comprising:
a face;
a sole; and
a crown including a crown member,
the crown member including
a first member including a fiber-reinforced resin; and
a second member of a metallic wire, the second member having a higher flexural rigidity in a toe-heel direction than in a face-back direction.

9. The golf club head as claimed in claim 8, wherein the first member has substantially a same flexural rigidity in the face-back direction and in the toe-heel direction.

10. The golf club head as claimed in claim 8, wherein the first member has a higher flexural rigidity in the toe-heel direction than in the face-back direction.

11. The golf club head as claimed in claim 10, wherein the first member includes an additional member of a fiber-reinforced resin, the additional member being so oriented as to have a fiber direction in the toe-heel direction.

12. The golf club head as claimed in claim 8, wherein
the crown member further includes a plurality of third members of a fiber-reinforced resin including glass fibers, and
one of the plurality of third members is placed inside the second member and another one of the plurality of third members is placed outside the second member in the golf club head.

13. The golf club head as claimed in claim 12, wherein one of the plurality of third members is placed at an outermost layer of the crown member, and is so transparent as to make the second member visible from an outside of the golf club head.

14. The golf club head as claimed in claim 12, wherein the glass fibers are woven crisscross.

15. The golf club head as claimed in claim 8, wherein the second member is elongated in the toe-heel direction.
